(19) United States
(12) Patent Application Publication
(10) Pub. No.: US 2008/0120243 A1
(43) Pub. Date: May 22, 2008

(54) Contractor's smart card device and method

(76) Inventor: Janeice Lakin, Kissimmee, FL (US)

Correspondence Address: FRANK B. ARENAS, Esq., P. O. BOX 600, 2327 TAYLOR AVENUE, COLEMAN, FL, 33521, US

(21) Appl. No.: 11/601,896

(22) Filed: Nov. 20, 2006

(51) Int. Cl. H04L 9/32; G06Q 10/00

(52) U.S. Cl. 705/72; 705/73; 705/1

(57) ABSTRACT

A method for contractors working in single or multiple buildings or facilities to have a standardized card that would contain all information required by facilities personnel. This card allows facilities personnel to obtain the necessary personal, licensing, insurance, and other required information to pull building permits from local government building departments without requiring contractors to interview and complete paperwork. This provides an advantage to both building personnel and contractor over present methods. The contractor procures the card from a granting agency. The card can be designed for use either in secure or non-secure facilities. The secure card would be read at access terminals located at facility entry points. That card would contain all information required for access or application for building permits. This would save the considerable time spent by both the contractor and security personnel in gathering the information for temporary workers. In the preferred embodiment, the card is a smart card with a chip contained therein that may be queried.

### BACKGROUND OF THE INVENTION

1. Field of the Invention

Versions and embodiments of the present invention relate generally to building contractor identification and building permits obtained from government building departments. More particularly, versions of the invention relate to devices and systems to streamline the building permit application process by contractors as required by government building departments. Specifically, a version of the invention relates to a smart card device, system and method to enable contractors to reduce time spent obtaining building permits and access to secure buildings and new, useful and unobvious versions thereof.

2. Description of the Related Art

A need exists in the building contractor trade and industry to streamline the building permit application and issuance system. In the US, for example, most states are comprised of different legal jurisdictions of counties (or parishes) and municipalities (cities). As is well known to one skilled in the art, most, if not all, states, counties and/or cities require building contractors to be licensed for the type of work (i.e. residential or commercial) and sub-work (heating, ventilation, air conditioning (HVAC), electrical, plumbing etc.), for which a building permit is to be issued. The building permit issued by a government authority allows a building to be built new on vacant land and/or to remodel or add to an existing building.

Other requirements are placed on building contractors by some jurisdictions. Liability insurance, workman's compensation, hazard insurance, completion bonds, occupational licenses, continuing education credits, payroll taxes, etc. (which is intended to be illustrative and not limiting) are required in some jurisdictions like Florida. Different counties in Florida might require different licenses, bonds, etc. for the building contractor to operate and “pull” building permits (as is known in the industry) from the local government building department prior to commencing work.

Prior to allowing a building contractor to submit an application to pull a permit, the contractor must submit her credentials to the government building department to prove qualifications, licenses, insurance, etc. and other type requirements. This is time consuming for both the building contractor (“contractor”) and the building department personnel to manually submit, enter, verify and approve the authority of the contractor to pull the permit in that particular jurisdiction. Usually the contractor must wait in line for long periods of time to interact with the building dept. staff, wasting valuable time.

Current events have created a heightened security requirement for entry into buildings. Security considerations now restrict access even by employees and contractors who work in them. Employees usually wear badges with a photo ID. They get the badges from the security departments of their employers. They scan their badges at stations that allow access to specific areas. It is a little more difficult with contractors. They must be controlled to a greater degree than employees. Some contractors are licensed, and others are not.

Many contractors work in multiple and often unaffiliated buildings. Their information must be accessible to all of the buildings. The required information could include data such as name, address, phone numbers, state licensing information (for all states in which contractor is licensed), employer name (if a sub-contractor) insurance information, etc. Currently, contractors go through a process similar to that for employees to perform temporary work in a building. They go to the building security department, fill out forms, and then receive their access badges. Sometimes the badges have photo ID's, and sometimes they do not.

Different states differ in their policies for providing identification to licensed contractors. Some states provide no identification at all. Florida, for example, provides contractors with a stock card without a picture, a barcode, or a magnetic stripe. It only provides them with an expiration date.

Within a given state of the US, different counties and municipalities have different requirements for building contractors and sub-contractors. When such a person first requests approval for work in a building, he or she must provide inter alia personal information (e.g., name, address, and telephone numbers), employment information, state license number, county and municipal occupational license information, liability and workman's compensation insurance information (e.g., insurance company names, agent names, policy numbers, bond numbers), and status of continuing education classes. Building security departments require this information of all contractors, and the process of collecting this information and clearing contractors, even in a non-secure facility, is extremely time consuming and burdensome. Building personnel would like to have a way of not repeating this process for every contractor applying to work in their buildings. Contractors, who work in several facilities in various counties and municipalities, also find the process of providing the information burdensome. They too would like to have a way of not repeating this process for every building in which they must work.

Government building departments typically have computer systems and software to process the building permit application, issuance, site inspections and certificate of occupancy (CO as it is known in the trade). Prior to allowing a building contractor to submit an application to pull a permit, the contractor must submit her credentials to the government building department to prove qualifications, licenses, insurance, etc. and other type requirements. This is time consuming for both the building contractor (“contractor”) and the building department personnel to manually submit, enter, verify and approve the authority of the contractor to pull the permit in that particular jurisdiction. Usually the contractor must wait in line for long periods of time to interact with the building dept. staff, wasting valuable time.

For instance, if a contractor has 3 new structures to be built in 3 different counties in Florida, for example, she must go to the first county, stand in line, wait for staff to be available to start the permit application process, produce paper/physical copies of licenses, bonds, insurance, etc. to the building dept. staff for manual entry into the dept.'s computer system. Then the same procedure must be followed in the second county and then again in the third county. This is time consuming and wastes valuable human resources.

A smart card is known in the art as a pocket-sized card that has embedded chips or integrated circuits. This type of card is also known as an integrated circuit card (ICC). There are two different types of smart cards:
Memory Card—This type of card contains read-only data and perhaps specific security logic.
Microprocessor Card—This type of card contains microprocessor components in addition to nonvolatile memory.

Ordinarily, when a person hears the words “smart card,” he or she thinks of a plastic card which is the size of a credit card. However, smart cards come in all different sizes and shapes. One example is a GSM SIM card commonly used in cellular telephones. As smart cards are normally used in the art, many come with various tamper-resistant devices, encryption, data security, etc. They are capable of maintaining the confidentiality of information stored in their memories. The security features are available both on memory cards, and on microprocessor cards. Patents relevant to smart card technology are:
U.S. Pat. No. 3,971,916—Methods of Data Storage and Data Storage Systems
U.S. Pat. No. 4,007,355—Data-Transfer System
U.S. Pat. No. 4,092,524—Systems for Storing and Transferring Data
U.S. Pat. No. 4,102,493—Systems for Storing and Transferring Data
ES Patent ES2186534—Smart Card Reader for Authentication and e-Payment, Including USB Token.

Smart cards have been used as credit cards, debit cards, electronic purse cards, GSM SIM cards, and public transportation fare cards. Their use is currently being contemplated for personal identification and entitlements at regional, national, and international levels. In Europe, citizen cards, driver licenses, and patient medical cards are prevalent. Smart cards are currently being integrated into passports of many countries to enhance security for international travel. Two different card modes are currently used in the art:
Contact Smart Card—A small gold chip is placed either on the front or the rear surface of the card. When the card is inserted into a card reader, the chip makes electrical contact with connectors within the card reader. In this way, the card reader can read information from the chip and write information back onto the chip.
Contactless Smart Card—The chip in this card communicates with a card reader via RFID. It is often used when transactions must be processed quickly or hands-free, such as on mass transit systems, or toll payment systems, or it can be used without even removing them from a wallet.
   Smart cards do not have an embedded battery. Instead, they used a built in inductor to capture the incident radiofrequency interrogation signal, rectify it, and use it to power the card's electronics.

### SUMMARY OF THE INVENTION

A device, system and/or method disclosed in versions of this invention solve these needs in the industry. A central “clearing house” or agency is established that allows contractors to input once all qualifying information to pull permits in one, some or all jurisdictions and use a smart card or token to apply in different jurisdictions with minimal human interaction.

It would be desirable for a contractor to have a single secure access card that contains all required information. That card can be used in multiple buildings provided that they have the proper access terminals. This would save time and paperwork for the contractors and building permitting departments throughout the United States and abroad. It would also eliminate human error in the application process. The building permitting department and/or security department will know that the contractor's computer information is stored and automatically updated when he or she pays for state licenses, insurance, occupational licenses, and completes and passes continuing education classes. The card represents a convenience for both building department personnel for issuing building permits and the contractor, even if the card is not used for secure access to buildings. However, even a secure-access card need not be used only for access to buildings. It can be used at any secure location. For example, airports and other transportation locations can also use this system for entry.

With this card contractors will eliminate:
applying for contractors registration at every building/licensing department under which they work;
waiting for insurance companies to FAX all insurance requirements; and
human error.

Various embodiments of this new, useful and unobvious invention reduce this time consuming procedure and need for manual data entry, increasing efficiency and reducing administrative expense.

Government building departments typically have computer systems and software to process the building permit application, issuance, site inspections and certificate of occupancy (CO as it is known in the trade). Typical software used by government building departments for the above-referenced purposes is similar to those offered by SunGard Corporation, 680 East Swedesford Road, Wayne, Pa. 19087, phone 1-800-825-2518, www.Sungard.com and Innoprise Software, Inc., 801 International Parkway, 5th Floor, Lake Mary, Fla. 32746, phone 1-407-562-1908, FAX 1-407-562-1808, www.innoprise.com (also known as vendor software). One embodiment of the invention uses a computer software interface to interact and input/output the contractor's information with appropriate vendor software already used by the government building department, such as the Community Development System “Permits and Inspections” by Innoprise. In this embodiment of the Present Invention, a smart card is swiped, triggering data to be collected by the building department's computer via an interface and the name, address, etc. of the contractor information is automatically entered into the electronic form of the vendor software. Thus, only minimal information regarding the specific project/building (location, address, type, etc.) need be manually entered by the building department's staff.

Some versions interact with the building department.'s software as described above. Other embodiments will streamline the building application and permit issuance via kiosk(s) located in various places, or even mobile kiosk(s). Another version uses smart devices and wireless networks to input the user-defined criteria and interact with the various databases required for verification of the contractor's credentials and acceptance of the permit application and issuance of the actual building permit to allow the contractor to commence work.

One version of the Present Invention discloses a method whereby a contractor applies for a licensing update card and/or a secure access card over the internet and/or World Wide Web (WWW) is granted that card by an agency (or clearing house). The agency maintains all of the necessary information for the contractor. An example of that information is:
1. name
2. telephone number(s)
3. employer and office address
4. state license number
5. insurance company name (agent and policy numbers) for general liability and workman's compensation
6. bond numbers
7. occupational licenses (city and county)
8. continuing education classes
9. etc.
10. any other user-defined criteria.
   For this to be accomplished, the following components are desired:
1. contractor's access card (e.g., swipe, smart card, etc.);
2. internet access software for card administration;
3. website for contractors to securely apply for card and pay (by credit card or any other payment means) and to view and verify their information;
4. access terminals (e.g., swipe kiosks) at building entry points, and;
5. sufficient computer hardware, software and peripherals for input/output.

Contractors apply for their cards through a central granting agency using the internet. In most cases, this agency would be non-governmental and privately operated. However, in the case where the facility is owned or run by the government, it is possible that the agency would be operated under the auspices of the government. The granting agency performs the necessary background checks. The background checks could be simple if a non-secure card is required (having only the information required by be collected by building personnel) or extensive if a secure card is required. If required, the contractors could initially appear in person at a local office for recording of biometric identification (e.g., photographing, fingerprinting, voice printing, etc.). Updates to the card are then done by the granting agency. If the card is a smart card, it contains a chip that can be queried by the access terminal, with or without an RFID chip for wireless inquiries. The contractor may also have a PIN code that he or she may use for entry. The PIN may be static or variable based upon the type of card.

The mere fact that a contractor has a card should not prevent individual building security departments from performing their own background checks for additional security. However, all up-to-date information is contained on the contractor's card for use by the security department.

The foregoing objects, benefits and advantages of versions of the invention are illustrative of those which can be addressed by various embodiments and versions of the invention and not intended to be limiting or exhaustive of the possible advantages that can be realized. These and other advantages will be apparent from the description herein or can be learned from practicing versions of the invention, both as embodied herein as examples or as modified in view of any variations which may be apparent to those of ordinary skill in the art. Therefore, the invention resides in the novel devices, methods, arrangements, systems, combinations and improvements herein shown and described as examples and not limited therein.

It is understood that the versions of the inventions are new device(s), method(s) and/or system(s) more advanced than traditional contractor customs and trade.

### BRIEF DESCRIPTION OF THE DRAWINGS

In the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a flowchart that shows how a contractor applies for and is granted a card by a granting agency.

FIG. 2 is a schematic illustrating the process of granting access cards by the agency.

FIG. 3 is a flowchart that shows how a contractor uses his or her access card in a building.

FIG. 4 is a flowchart that shows how a smart card is used in conjunction with software and a data base in order to grant a permit to a contractor.

It should be understood that in certain situations for reasons of manual or computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawings (and some embodiments not shown in the drawings), these details are not intended to limit the scope of the invention.

### DETAILED DESCRIPTION OF THE PREFERRED EMBODIMENT

It is understood that whenever and/or is used in this patent application it means any combination or permutation of all, one, some, a plurality or none of each of the item or list mentioned, which is not intended to be limiting but merely for example and illustration. It is also understood that (s) designates either singular or plural. It is also understood that that “or” is an inclusive “or” to include all items in a list and not intended to be limiting and means any combination or permutation of all, one, some, a plurality or none of each of the item or list mentioned. It is also understood that “including” means “including but not limited to” any combination or permutation of all, one, some, a plurality or none of each of the item or list mentioned.

Initially, a central granting agency must be established. Theoretically, there could be a number of agencies that perform this service competitively. In that event, a single standard should be maintained between them. Otherwise, the card will not receive wide acceptance by building personnel. In the preferred embodiment of this invention, there would only be one such agency (hereinafter referred to either as the ‘central agency’ or merely the ‘agency’). The agency maintains a website for contractor interaction. It may also have local or satellite offices at locations convenient to contractors. A local office may be owned by the agency, franchised, or run by third-party contractors.

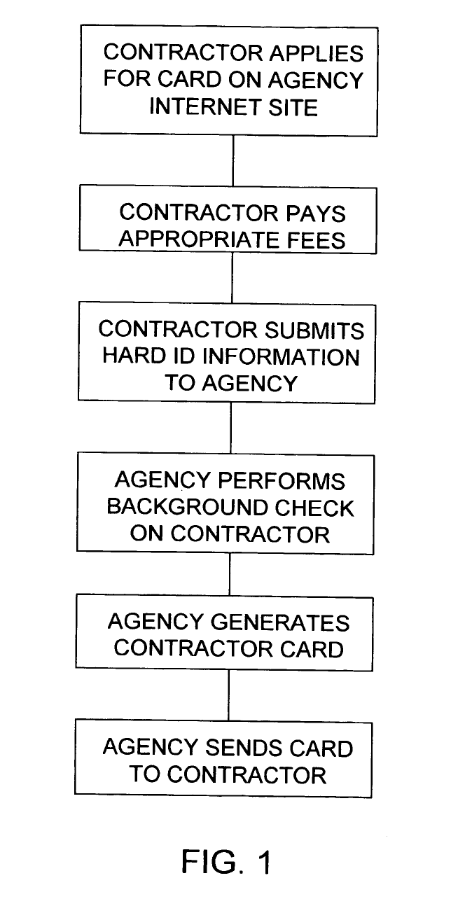

Referring to FIG. 1, a contractor applies to the agency for a card. If the contractor already has a card but wants to update the information contained thereon, then the process is the same. In the application or update process, the contractor answers questions on a web questionnaire. The agency then collects its fees from the contractor by credit card or any other type payment acceptable to the agency. The website next informs the contractor whether ‘hard’ information is required. Hard information is physical information which the agency retains in its computer files. That information would probably be required for a very secure access card and probably not be required for a non-secure access card. Hard information could include inter alia:

1. photocopies of birth certificate, drivers license, social security card, etc.;
2. photograph(s) of contractor;
3. biometric data (e.g., fingerprints, voice prints, etc.); and/or,
4. photocopy of signature (signed in front of authorized agent), and;
5. any other user-defined criteria.

This hard information could be obtained from the contractor in-person. If it is required, the contractor would go to the nearest local office. Once, all pertinent information is received, the agency performs a background check on the contractor to verify all of the information provided. If the information checks out, then the agency generates a card, and sends it to the contractor. In the preferred embodiment, the card would be a smart card. This card would contain an internal chip that could be queried. The contractor receives a PIN, which could be variable and complex. For example, the contractor might have a separate key device that would generate a PIN based upon querying the smart card. The contractor would then use that one-time PIN for that particular access to a building. So, a card could be fabricated that would be quite secure. Or, token(s) (comprising a sign, indication and/or symbol) could be used by the agency. The smart card and/or token to the contractor are tangible and concrete results of versions of the invention.

In some buildings where access security is not required, the card would be used ease the burden of collecting information from the contractor by building department personnel for work permit applications and/or security personnel. Once this is accomplished, the contractor would have unimpeded access to the building, and further use of the card in that building would not be required. Or, work permit applications are automatically filled-in by the card, eliminating redundancy and saving time.

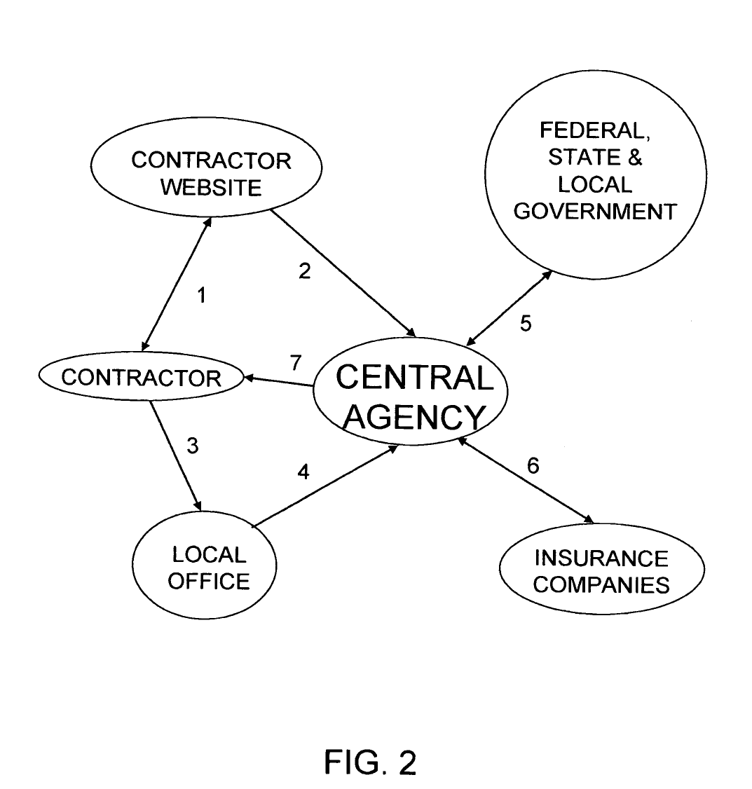

The application process flow is illustrated in FIG. 2. The sequence of events is as follows:
1. Contractor contacts the agency/contractor website in an interactive session.
2. Information from the website is transmitted to the central agency.
3. If required, contractor goes to a local agency office to submit hard information.
4. Information from the local office is transmitted to the central agency.
5. Central agency verifies contractor submitted information with government agencies. Examples of such information might be birth records, licensing information, fulfillment of requirements, etc. and any other user-defined criteria.
6. Central agency verifies contractor submitted information with insurance companies. Examples of such information might be agent name, workman's compensation, liability insurance, etc. and any other user-defined criteria.
7. Finally, if background check of contractor checks out, the central agency generates a card and sends it to the contractor.

An additional requirement of versions of the Present Invention is that participating secure buildings have access terminals at their entry points. These terminals could be kiosks (either stationary or mobile) or turnstiles with attachments that read cards, scanners, card insertion devices, or any other type of terminal which can read the card. It is envisioned that standard terminals would be used in all participating buildings. These access terminals could also be configured to read employee badges.

On the other hand, a participating non-secure building or building departments for permit applications would have a card reader peripherally attached to a desktop computer. This would simplify the process whereby building personnel obtain necessary information from a contractor. A secure facility would also have such a setup in the building security office. Licensing, insurance, and personal information is required by building security and/or permitting personnel in both secure and non-secure facilities.

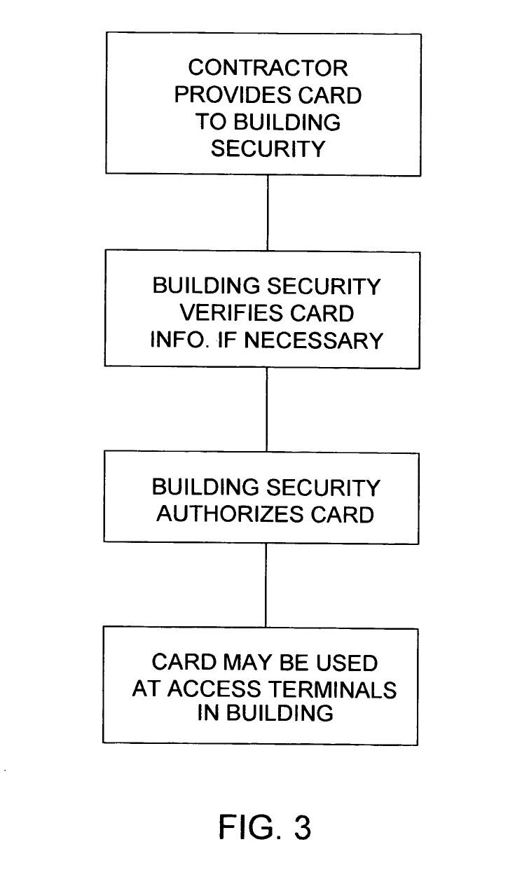

FIG. 3 shows how a card would be used by the contractor. Initially, the contractor submits his or her card to building security and/or building department permitting personnel. The identity of the contractor and the information on the card may be independently verified by building security if necessary and/or build department personnel. In any event, all of the contractor's required information is contained on the card. So, filling out forms and re-verifying every piece of information is unnecessary. In a secure facility, if the card and identity check out, building security authorizes the card for use in the particular building (or multiple buildings under the control of the same entity). To gain access to the building or apply for a building work permit, the contractor now need only use the access terminal to read his or her card.

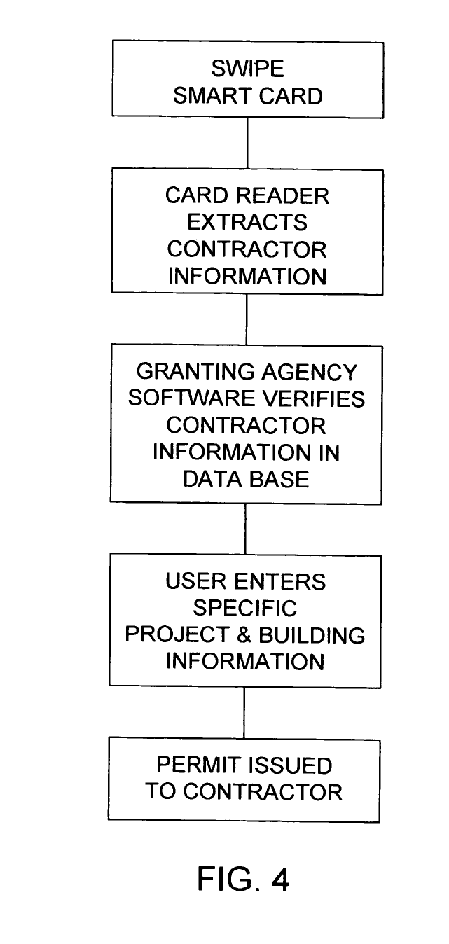

FIG. 4 is a flowchart that shows how government building department personnel may issue a permit to a contractor for a specific project at a specific building location. The contractor's smart card is scanned into the card reader. This automatically enters the contractor's personal information into software residing either on a computer attached to the computer or central agency software accessed either via dialup modem or via the internet. Information from a data base associated with the software is used to validate that which is read from the smart card. The user at the building department manually enters information about the specific project and building location. Once this is done, a permit is issued to the contractor.

The procedures for the use, navigation, input of data and interaction with the web site are well known in the industry such as point-and-click on hyperlinks with a computer mouse computer input device, filling in electronic forms, sending/receiving email, speaking to the web site and listening to the web site via Voice over Internet Protocol (VoIP) The users may communicate in question and answer format via a voice synthesizer connected to a processor. The web page input data is evaluated by the operator. The input data may be stored in computer memory, etc. in a like manner of the current interactive web sites available on the Internet and/or the World Wide Web (www) today, well know in the art.

The above-referenced menus, lists, options, functions, instructions, commands, sub-commands, applications, interactions, items, groups and sub-groups are merely intended as illustration and examples, and are not intended by the inventor to in any way limit the addition, deletion or modification of any said menus, lists, options, functions, instructions, commands, sub-commands, applications, interactions, items, groups and sub-groups as might be desirable or useful to someone skilled in the art.

Some examples of embodiments of the invention may be illustrated. For example the invention may be practiced with a laptop computer comprising sufficient hardware, software, accessories and peripheral devices or and/such, etc.

Or, the invention may be practiced with a computer system in communication with at least one other computer or at least one remote input device further comprising sufficient hardware, software, accessories and peripheral devices interacting with other optional entities' data to generate input/output via cell phone, smart phone and/or email or other smart device.

Or, the invention may be practiced with a computer system (server) further comprising sufficient hardware, software (WWW browser and/or email program), accessories and peripheral devices based at an Internet Service Provider (ISP) location in communication via the Internet and/or World Wide Web (WWW) via HTTP from the server to a client or with other computers or other remote input devices comprising sufficient hardware, software (WWW browser and/or email program), accessories and peripheral devices, and HTML or XML electronic preconfigured forms/monitor screens for input of contractor information using any other types of electronic communications (either wired or wireless). All components of the above-mentioned system are well known in the art.

As will be apparent to persons skilled in the art, such as a person in the contracting industry, computer programmer, building department permit application personnel, website designer and/or other similar-type individuals, various modifications and adaptations of the structure and method of use above-described will become readily apparent without departure from the spirit and scope of the invention, the scope of which is defined in the attached claims. Although the foregoing invention has been described in detail by way of illustration and example, it will be understood that the present invention is not limited to the particular description and specific embodiments described but may comprise any combination of the above elements and variations thereof, many of which will be obvious to those skilled in the art. Additionally, the acts and actions of fabricating, assembling, using, and maintaining the preferred embodiment of this invention is well known by those skilled in the art. The invention may be embodied in other specific forms without departing from the spirit or essential characteristics thereof. The present embodiment is therefore to be considered in all respects as illustrative and not restrictive, the scope of the invention being indicated by the attached claims rather than by the foregoing description, and all changes which come within the meaning and range of equivalency of the claims are therefore intended to be embraced therein.

I claim:

1. A method for a contractor working at a single facility or at multiple facilities to provide necessary information to building department personnel to obtain building permits comprising:
a. applying or causing to be applied to a granting agency that is not directly affiliated with the facility or facilities;
b. submitting or causing to be submitted required information to the agency;
c. allowing or causing to be allowed the agency to verify the submitted information;
d. receiving or causing to be received a token from the agency, said token containing data concerning the contractor;
e. submitting or causing to be submitted the token for authorization to building personnel associated with the facility or facilities;
f causing a terminal to read the data from the token.

2. The method of claim 1 wherein the facility or facilities is secure and the contractor requires secure access to the facility in order to work therein.

3. The method of claim 2 further comprising:
g. causing an access terminal at an entry point at any one of the secure facilities to read the data from the token; and,
h. entering the facility.

4. The method of claim 1 wherein the contractor submits required information to the agency over the internet.

5. The method of claim 2 wherein the contractor submits required information to the agency in person.

6. The method of claim 5 wherein the submitted information includes biometric data.

7. The method of claim 1 wherein the token is a card.

8. The method of claim 7 wherein the card is a smart card containing a chip that can be queried electronically.

9. The method of claim 3 wherein the access terminal is taken from the group consisting of: a kiosk having a card reader, a swipe attachment, a bar code reader, a magnetic stripe reader; and a device capable of interactively querying a smart card chip.

10. The method of claim 3 further comprising receiving or choosing a PIN and entering the PIN into the access terminal to gain entry to the facility.

11. The method of claim 8 further comprising:
receiving an electronic key device that is separate from the smart card, wherein said key queries the chip and calculates a one-time PIN; and,
entering the one-time PIN into the access terminal to gain entry to the facility.

12. A method for a contractor working in a single secure facility or multiple secure facilities to update data in a token containing data required by facility personnel, wherein the token is already possessed by the contractor, said method comprising:
a. applying to a security granting agency that is not directly affiliated with the secure facility or facilities;
b. submitting required information to the agency;
c. allowing the agency to verify the submitted information;
d. submitting the access token to the agency for updating; and,
e. receiving the access token from the agency, said token containing updated data concerning the contractor.

13. The method of claim 1 further comprising an interface with vendor software used by the building department personnel.

14. A device for a contractor working at a single facility or at multiple facilities to provide necessary information to building department personnel to obtain building permits comprising a computer programmed to perform the following steps:
a. applying or causing to be applied to a granting agency that is not directly affiliated with the facility or facilities;
b. submitting or causing to be submitted required information to the agency;
c. allowing or causing to be allowed the agency to verify the submitted information;
d. receiving or causing to be received a token from the agency, said token containing data concerning the contractor;
e. submitting or causing to be submitted the token for authorization to building personnel associated with the facility or facilities;
f. causing a terminal to read the data from the token.

15. The device of claim 14 wherein the contractor submits required information to the agency over the internet.

16. The device of claim 14 wherein the contractor submits required information to the agency in person.

17. The device of claim 14 wherein the submitted information includes biometric data.

18. The device of claim 14 wherein the token is a card.

19. The device of claim 18 wherein the card is a smart card containing a chip that can be queried electronically.

20. The device of claim 14 wherein the terminal is taken from the group consisting of:
a kiosk having a card reader, a swipe attachment, a bar code reader, a magnetic stripe reader; and a device capable of interactively querying a smart card chip.

21. A method for government building departments to grant a permit to a contractor to work on a specific project at a specific building location, wherein the contractor possesses a token containing machine readable information about the contractor, said method comprising:
a. causing the information from the token to be extracted from the token by a device capable of extracting said information;
b. automatically entering the information extracted from the token into a programmed interface that allows computer software to process the information;
c. causing the software to validate the information;
d. manually entering data concerning the specific project and building location into a device that interfaces with the software;
e. causing a permit to be issued to the contractor based upon the information extracted from the token and the manually entered data.

22. The device of claim 21 wherein the token is a card.

23. The device of claim 22 wherein the card is a smart card containing a chip that can be queried electronically.
